(19) United States
(12) Patent Application Publication
(10) Pub. No.: US 2009/0106644 A1
(43) Pub. Date: Apr. 23, 2009

(54) MODIFYING PROJECTED IMAGE AREA (mask) FOR DISPLAY

(76) Inventors: Edward W. R. Bagg, Port Coquitlam (CA); Robert A. Taylor, Port Moody (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/874,586

(22) Filed: Oct. 18, 2007

(51) Int. Cl. G06F 15/00

(52) U.S. Cl. 715/235

(57) ABSTRACT

A ShapeShifter software component selects and modifies a mask associated with a presentation device. The ShapeShifter software component receives input to select the presentation device from a plurality of presentation devices. The Shape Shifter software component displays a mask associated with the selected presentation device, displays mask modification tools for associated mask, and allows utilization of one of the mask modification tools on the selected mask to create a modified mask. In an embodiment of the invention, the ShapeShifter software component controls a presentation management system by first establishing a plurality of projection devices. The ShapeShifter software component creates a room layout for the plurality of projection device and creates a presentation list for at least one of the plurality of projection devices. The ShapeShifter software component modifies a content file and creates a mask for at least one of the plurality of projection devices.

### BACKGROUND OF THE INVENTION

1. Field of the Invention

The present invention relates generally to improvement in configuring and managing in-store or remote location retail display terminals and particular to a system and methods for configuring the setup and management of in-store or remote location retail display terminals to be able to display images on a number of different viewing surfaces.

2. Description of the Prior Art

Current product advertising takes many forms, such as television commercials, newspapers and magazine advertisements, mailings, point of sale displays, outdoor billboard, etc. Using current advertising media, advertisers engage in a constant struggle to efficiently use their budgets in order to effectively reach their geographic and demographic targets. There is a need to create an automated system for displaying product production information to in-store retail customers in a coordinated and effective manner.

In addition, current advertising tends to be static and not targeted to specific audiences. Thus, advertising becomes dated and trends change quickly forcing advertisers to make costly changes in the static advertising media. Thus, there is a need to allow for easy creating, editing, and distributing of advertising media. There is also a need to accumulate statistical data relating to the display of information. There is an additional need to be flexible enough to have groups of in-store displays or presentation devices with identical or very similar presentations while at the same time have enough flexibility that individualized messages may be input to attract specific users in specific locations.

Further, different retail locations have different store layouts and display locations. Current presentation systems allow for remote locations to be monitored but do not address the setup of individual store locations, i.e., where presentation devices may be located and on what surfaces the presentations may be displayed. Thus, although the presentation may be controlled, an administrator may not know how the presentation may be viewed by a consumer in the retail store. Thus, a need exists for a system to allow an administrator to create a room layout that is close in shape to selected retail locations. Further, a need exists to allow an administrator to understand how a presentation is to be displayed on the presentation device in the remote location.

### BRIEF DESCRIPTION OF THE DRAWINGS

FIG. 1 illustrates a Shape Shifter software system according to an embodiment of the invention;

FIG. 2A illustrates a logical overview of the Shape Shifter software component according to an embodiment of the invention;

FIG. 2B illustrates the main screen with balloons identifying the different modules of the ShapeShifter software component according to an embodiment of the invention;

FIG. 2C illustrates a login screen according to an embodiment of the invention;

FIG. 2D illustrates a system menu according to an embodiment of the invention;

FIG. 2E illustrates the local configuration submenu according to an embodiment of the invention;

FIG. 2F illustrates the presentation color chooser submenu according to an embodiment of the invention;

FIG. 2G illustrates an importing data section of the Shapeshifter software component according to an embodiment of the invention;

FIG. 2H illustrates the importing data section of the Shapeshifter software component including the import new data feature according to an embodiment of the invention;

FIG. 2I illustrates a section of the importing data section of the Shapeshifter software component including an apply changes feature according to an embodiment of the invention;

FIG. 2J illustrates an edit media file screen according to an embodiment of the invention;

FIG. 3A illustrates a logical flowchart of a content load module or content management module of the ShapeShifter software component according to an embodiment of the invention;

FIG. 3B illustrates a content management screen according to an embodiment of the invention;

FIG. 4A illustrates a presentation management screen in the ShapeShifter software component according to the embodiment of the invention;

FIG. 4B illustrates a flowchart of operation of the presentation management module according to an embodiment of the invention;

FIG. 5A illustrates a flowchart of the assign presentation module according to an embodiment of the invention;

FIG. 5B illustrates an add presentation menu option according to an embodiment of the present invention;

FIG. 5C illustrates a effective dates edit window screen according to an embodiment of the invention;

FIG. 5D illustrates an effective dates edit window screen according to an embodiment of the invention;

FIG. 6A illustrates a flowchart of operation of the content personalization module according to an embodiment of the invention;

FIG. 6B illustrates a content personalization screen according to an embodiment of the invention;

FIG. 7A illustrates a flowchart of operation of the device management screen according to an embodiment of the invention;

FIG. 7B illustrates a device management screen according to an embodiment of the invention;

FIG. 7C illustrates the device grouping selector subscreen according to an embodiment of the invention;

FIG. 8A illustrates a flowchart for operation of the floor setup module;

FIG. 8B illustrates a floor layout screen according to an embodiment of the present invention; and

FIG. 9 illustrates a mask obscuring part of a content file image according to an embodiment of the present invention.

### DETAILED DESCRIPTION OF EMBODIMENTS OF THE INVENTION

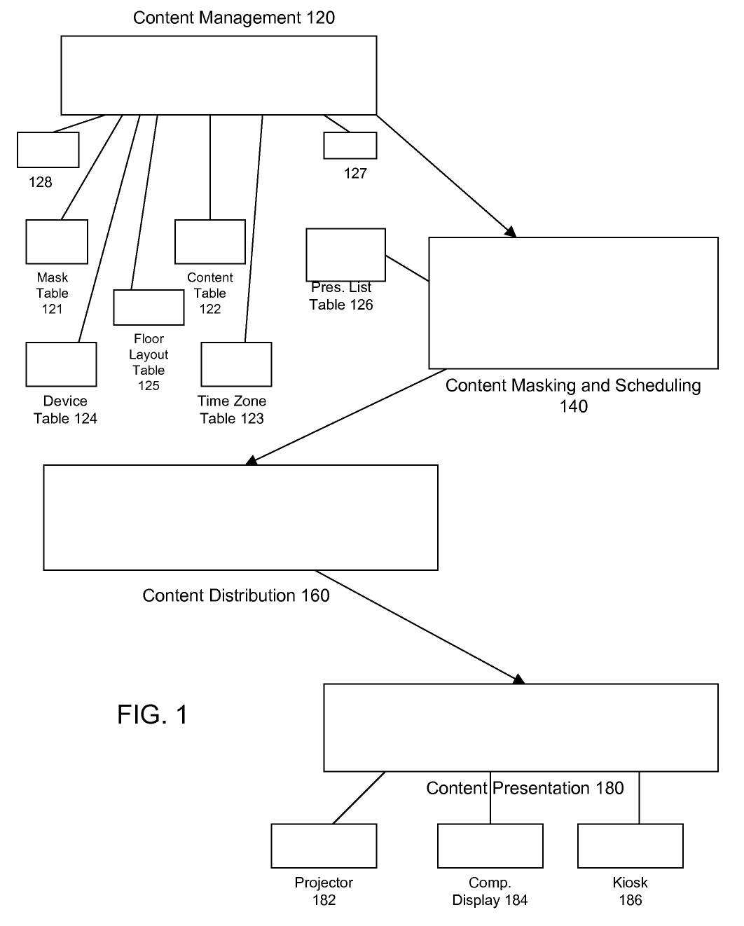

FIG. 1 illustrates a digital marketing system according to an embodiment of the present invention. The Epson ShapeShifter software component is a graphical user interface to allow a user to interface with backend systems of the digital marketing system. The Epson digital marketing system 100 includes a content management subsystem component 120, a content masking and scheduling component 140, a content distribution component 160, and a content presentation subsystem component 180. In an embodiment of the invention, the content management subsystem component 120, the content masking and scheduling component 140, and a content distribution component 160 may be located at one physical location. In an embodiment of the invention, the content management subsystem component 120, the content masking and scheduling component 140, and a content distribution component 160 may be located on one server, or, alternatively, on a number of servers.

If the content management subsystem component 120, the content masking and scheduling component 140, and the content distribution component 160 are located at different physical locations, or on different computers, the multiple computing devices may communicate with each other via a global communications network such as the Internet, a local area network, a wide area network, or a sub-network. The global communication network may be a packet-switched network In other embodiments of the invention, the communications network may be an ATM network or may utilize another data communication protocol. The content presentation subsystem component 180 may be located at a different physical location from the content management component 120, the content masking and scheduling component 140 and the content distribution component 160 because the content presentation subsystem component 180 is located at a same physical location as, or close to, the presentation devices which display the advertising content.

The content management subsystem component 120 includes features of drag and drop loading of advertising content, creating devices, creating masks for specialized device areas, and associating devices, content, and masks for presentation. The content management subsystem component 120 is coupled, or alternatively connected, to a plurality of databases. In an embodiment of the invention, the content management subsystem 120 component may include a centralized database. The centralized database may include a number of tables. This may be housed in a database server. In embodiments of the invention, the centralized ShapeShifter database may be housed on multiple physical servers. The configuration depends on the amount of data being stored, the size of the servers including the database, and security requirements for the information stored in the Shapeshifter database. The ShapeShifter database may be referred to as a stateful database The centralized database may include a plurality of tables, where the tables include information regarding different aspects of the digital marketing system (including the ShapeShifter information. In an embodiment of the invention, the plurality of tables may include a mask table 121, a device table 124, a content table 122, a floor layout table 125, and a time zone table 123. The centralized database may also include a presentation list table 126, a content personalization table 127, and presentation list to device table 128, which associates presentation lists with devices.

The content management subsystem 120 includes a build content database module, an associate masks with devices module, a build time-zone lists module, a build masking database module, a map device to store layout module, and a build device database.

The content mask and scheduling subsystem component 140 includes modules to associate specific content with devices and to create display lists for the devices to use in an automated fashion. The content masking and scheduling subsystem 140 includes a build presentation lists module, an associate presentation lists with devices module, an associate time-zone with device module, and an assign play sequence and duration length of presentation module. The content mask and scheduling subsystem is coupled, or alternatively connected, to a presentation list table 126.

The content distribution subsystem component 160 includes functionality to transfer the presentations (including display content) to the various devices. The devices utilize the information to properly display ads and content. The content distribution subsystem 160 includes a device synchronization module, a content and instruction delivery module, a statistics gathering module, a system maintenance module, a command and control sequencing module, and a reporting module.

The content presentation subsystem component 180 brings the content to life or activates the content, by utilizing the presentation list and the supplied content. The device(s) runs through the required display sequences specified by the presentation list and associated content. The content presentation subsystem 180 includes a content masking module, a content sequencing module, a statistics generating module, a device management module, and content presentation to device module. The content presentation subsystem 180 may be coupled or connected to one of a number of devices. The device on which presentations were displayed may be a projector 182, a computer display 184, or a kiosk 186. In an alternative embodiment of the invention, the presentations may be displayed on a continuous play device. For the remainder of the present application, the applicant generally refers to objects where the presentations are displayed/generated as devices, but the devices may be machines such as projectors, computer displays, kiosks, or other display devices. The content presentation subsystem component allows for semi-autonomous control of the presentation devices. The presentation devices automatically turn on and off according to scheduled run times. The presentation devices collect statistics regarding operation of the device as well as the content that is played on the presentation device. In addition, the presentation devices received modified or added information regarding the presentation device and/or content, and update the information in the memory of the presentation device.

The Shape Shifter software component of the digital marketing system is a Graphical User Interface (GUI) that allows a user to interact with parts of the digital marketing system (which may be referred to as the Epson SmartTouch or digital marketing system). Illustratively, the ShapeShifter software component may interact or interface with the backend systems of the digital marketing system. A “backend” system may be any system that an administrator or user interacts with to load content, to create a mask, to schedule presentations, or to configured devices. Under certain operating conditions, the “backend” system may include the content management subsystem 120 and the content masking and scheduling subsystem 140. More specifically, the ShapeShifter software component is intended to provide an intuitive way for users to perform four major tasks: (1) manage content on the backend; (2) create/edit presentations; (3) assign and schedule presentations to devices; and (4) tailor displays of presentations via masking.

Under certain operating conditions, the GUI of the Epson ShapeShifter component helps the user perform these tasks by organizing the configuration of the system in a logical order. Illustratively: (1) Media information is loaded onto the back end systems; (2) Presentations using the media information are created and edited; (3) A single group or groups of presentations (the play lists or presentation lists) are assigned to devices; (4) Temporary or personalized content is added for particular devices; (5) Masks are created if necessary and assigned to devices; and (6) Media re-positioning is performed, if necessary, in relation to device masks.

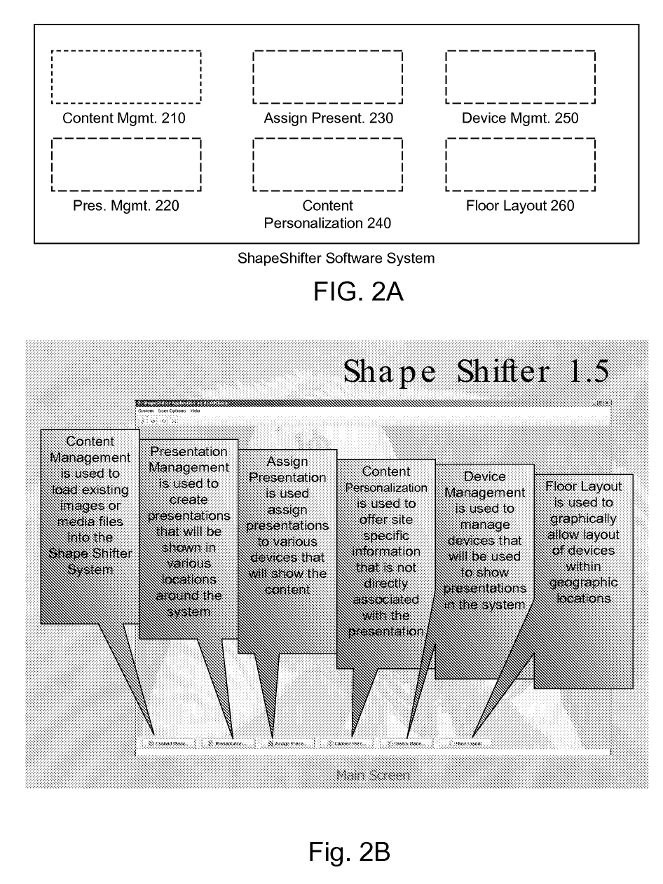

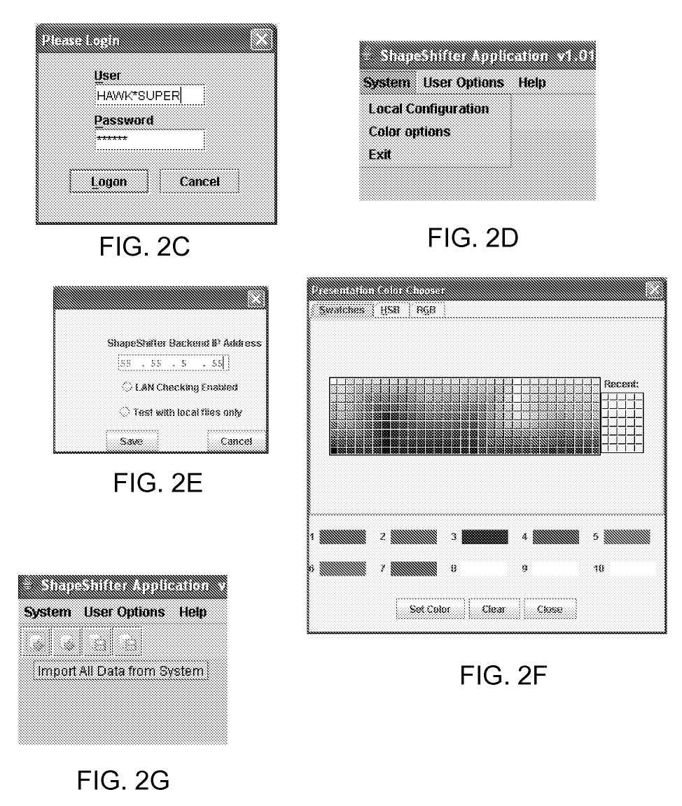

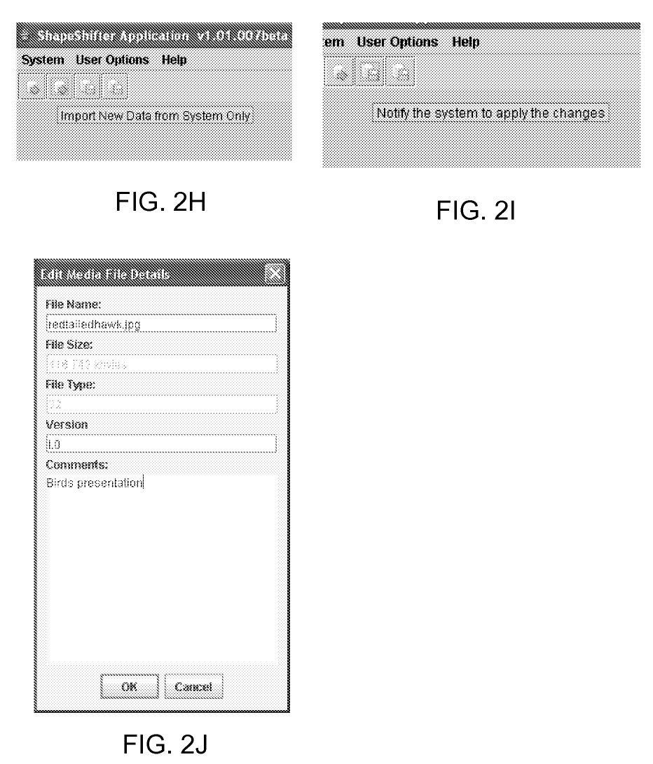

FIG. 2A illustrates a logical overview of the Shape Shifter software component according to an embodiment of the invention. The Shape Shifter software component includes a content management module 210, a presentation management module 220, an assign presentation module 230, a content personalization module 240, a device management module 250, and a floor layout module 260.

The content management module 210 is used to load existing images or media files into the Shape Shifter software system. The presentation management module 220 is used to create presentations that are shown at various locations around the digital marketing system. The assign presentation module 230 is utilized to assign presentations to various devices which later display the content of the presentations.

The content personalization module 240 is used to offer site specific information that is not directly associated with the presentations or presentation list. The device management module 250 is used to manage the devices show or display the presentations within the digital marketing system. The floor layout module 260 is used to graphically allow layout and setup of presentation devices within geographic or site locations.

The ShapeShifter software component is started by double clicking the desktop icon or selecting a Start menu item on a screen of a laptop computer, a desktop computer, a network computer or any other computing device on which the ShapeShifter software component is installed. The ShapeShifter software component may be a client software that interfaces with server software, e.g., the Epson SmartTouch digital marketing software. Overall control of the ShapeShifter software component is achieved through a series of drop-down menu items and toolbar buttons.

The ShapeShifter software component is designed for platform independence. Illustratively, when the ShapeShifter software component is started the user is presented with a set of options that are laid out in logical workflow fashion. Illustratively, FIG. 2B illustrates a main menu screen with balloons identifying the different modules of the ShapeShifter software component according to an embodiment of the invention. Each subcomponent (which are represented by buttons on the bottom of the main menu) are available for selection via buttons in a left to right sequence of how work may performed. Under certain operating conditions, the sequencing of the selection buttons may be rearranged as desired by the end user or administrator to better match their individual workflow activities. For example, in FIG. 2B, an administrator may move the context management selection button from its current position (at the furthest left spot) to the fourth position of the six buttons, which is currently housing the content personalization selection button.

As a subcomponent is selected the main screen sections configure themselves to the functions to be performed in that subcomponent. In other words, a display section in the main display screen is displayed to allow the performing of the selected operation. For example, if the presentation management screen is selected, a section (or number of sections) allows the presentations to be created or edited. The screen sections for the different components or modules (e.g., the assign presentation module, the device management module, etc.) are consistent to ensure familiarity of workflow and function selection between the different components of the ShapeShifter software.

In the ShapeShifter software application, the software module or component software selection buttons may be moved to a different location on the main screen. In FIG. 2B, the location is the bottom of the main screen, the selection buttons may be moved to the right hand side of the screen, the top of the screen, etc. Under certain operating conditions, the selection buttons may be hid from the administrator and not displayed on the main screen unless authorized by the administrator. The selection buttons may also be identified by different names. For example, the content management module selection button may be labeled “Epson's content input screen.”

As discussed above, the main screen, illustrated in FIG. 2B, is the controller of the various components. FIG. 2B illustrates the main screen with balloons identifying the different modules of the ShapeShifter software component, i.e., the content presentation, the presentation management, the assign presentation, the content personalization, the device management, and the floor layout modules. The main screen of the ShapeShifter software component also controls the administrative functions such as logging on/off, editing environment variables that are common to the application, establishing user management criteria, and editing individual user details.

FIG. 2C illustrates a login screen according to an embodiment of the invention. The login screen utilizes a username and password set up by the administrator when configuring the ShapeShifter software component. By selecting “Cancel” in the login screen, features in the software are not available and the login screen closes to exit the ShapeShifter software component completely.

FIG. 2D illustrates a system menu according to an embodiment of the invention. From the system menu, a local configuration submenu may be selected. The selection of exit quits the Shapeshifter software component. FIG. 2E illustrates the local configuration submenu. The local configuration submenu establishes the Internet Protocol address, e.g., for communicating with the various database and backend management components. Under certain operating conditions, only one IP address is established at a time. Thus, in another embodiment of the invention, multiple people may be utilizing the application and the system may be spread onto two servers. Different IP addresses may be established.

The local configuration submenu also allows for enabling of LAN checking functionality. The local configuration submenu also allows the establishing of local test options, e.g., testing only with local media files.

The system menu also includes a menu option for the selection of colors in the presentation panel layout. FIG. 2F illustrates the presentation color chooser submenu.

The Shapeshifter software component also includes a user options menu that allows the changing of the user, logout, changing of the user password, and editing of current user information. If there is no user, then the Shapeshifter software component brings up the login screen. If logout is selected, the current user is logged out, but the Shapeshifter software component continues to operate. If there is unsaved information, a prompt is displayed to request the saving of the unsaved information. These local configuration selections are persistent between sessions of use with the Shapeshifter software component. If a different end user system is utilized, the configuration information can be used to maintain consistent user experience. In other words, no matter what system a user or administrator logs into, the experience will be the same because the configuration and operational parameters are consistently maintained for the user or administrator.

After users are logged in, information may be loaded into the digital marketing system via the Shapeshifter software component. FIG. 2G illustrates an importing data section of the Shapeshifter software component according to an embodiment of the invention. The “Import All Data from the System” button (or drop down menu item) may be selected to download data from the database server. The downloaded data may include content (media files), presentation details, presentation playlists, device information and other presentation variables that have been set up by the Administrator at the database server, or in a previous session by a user. The “Import All Data from the System” button (or menu item) may be done at the start of any session in which you wish to work on the database.

FIG. 2H illustrates the importing data section of the Shapeshifter software component including the import new data feature according to an embodiment of the invention. The “Import New Data from System Only” button (or alternatively drop-down menu) may be selected to retrieve all data for the logged-in user that has changed since the user last retrieved information from the database server or database servers. Under certain operating conditions, this may happen automatically when a user or administrator logs into the system. The information may be retrieved from a centralized database. This may be referred to as the stateful database. Under there operating conditions, any data in any or all of the tables associated with the user may be updated. For example, information from the presentation list table, the device table, and/or the content personalization table may be updated. Thus, if a change has been made, the information is sent to the correct table and updated.

FIG. 2I illustrates a section of the importing data section of the Shapeshifter software component including an apply changes feature according to an embodiment of the invention. The selection of the “Notify the system to apply the changes”, causes the backend (e.g., the database servers and associated devices) to apply any changes that users may have made during operation of the ShapeShifter software component. Illustratively, all changes are saved from users' individual screens to the respective databases.

FIG. 2J illustrates an edit media file screen according to an embodiment of the invention. The edit media file screen allows a user to edit information about a file. For example, the user can edit the version number and place comments regarding the media file into the system.

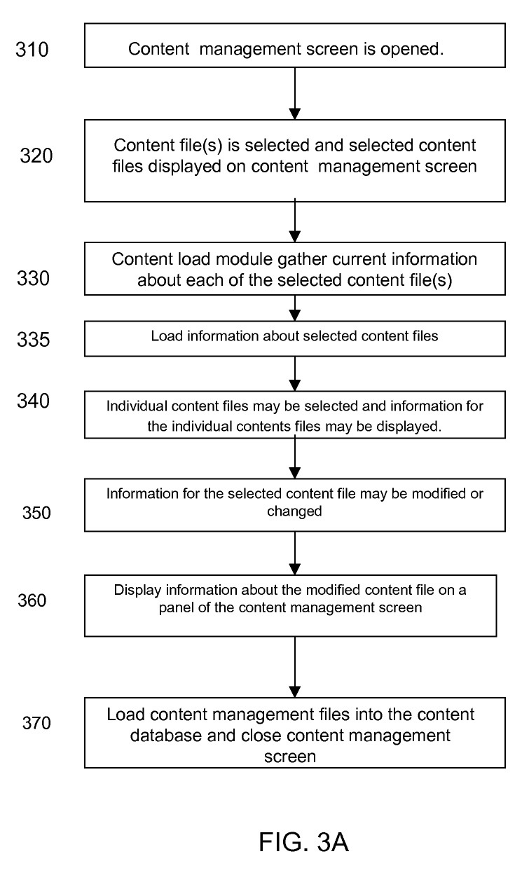

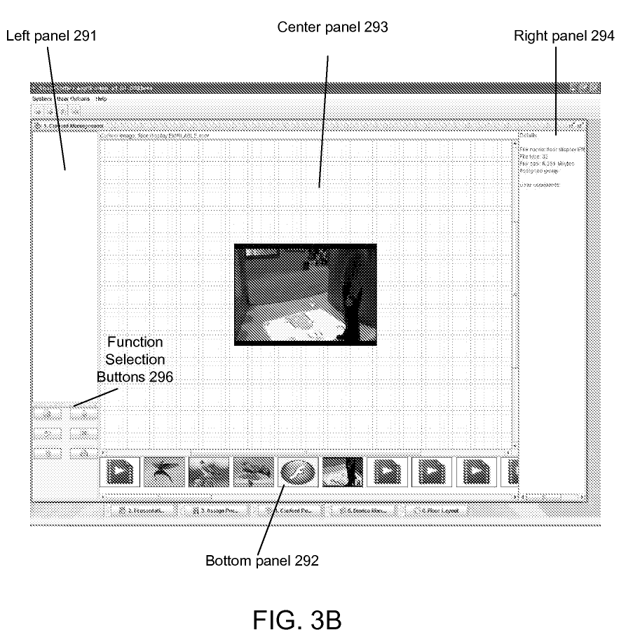

FIG. 3A illustrates a logical flowchart of a content load module or content management module of the ShapeShifter software component according to an embodiment of the invention. The content load or management module 210 (see FIG. 2A) receives the created content and loads the content via the ShapeShifter software component into the associated databases and the digital marketing system (e.g., the Epson SmartTouch system). In an embodiment of the invention, the content is originally received by an organization, such as the marketing staff. In the content load or management module 210, a content management screen is opened 310. Under certain operating conditions, location of the content files are listed on a side (e.g., left side) of the content management screen. Under certain operating conditions, a number of content files are selected 320 from the side of the content management screen and the selected number of content files are moved into a display section of the content management screen. The content load module 210 gathers 330 current information about each of the selected content files. For example, the current file information may include the file name, the file size, and/or image attribute. The content load/management module 210 loads 335 this current file information into a content database (e.g., content table 122).

After the information is loaded 335 into a content table, individual content files may be selected 340. Under certain operating conditions, if a file is selected, a panel of the content management screen, (e.g., a right detail panel) may display information about the selected content file. Information for the individual content file may be added regarding the selected content file or information may be modified 350 for the selected content file. Illustratively, a unique identification of the content file may be selected. In addition, each individual content file may be assigned to a category in order to more easily find the content file and like similar content files in future searches. After the individual content file has been selected, content from the content file may be displayed 360 on a panel of the content management screen (e.g., a center panel). This may allow an individual to review the content to make sure that the information regarding the content file is accurate. After all content files have been loaded into the content table 122 of, the content management screen may be closed 370. When the content management screen is closed, information regarding the content files which has been added or modified may be sent to the content table 122 of the centralized database. An administrator may also transmit the changes in the content or added/modified information about the content files to impacted devices via a “go” button or synchronize button.

FIG. 3B illustrates a content management screen according to an embodiment of the invention. The content management screen includes a left panel 291 which lists the location of content within the Digital Marketing. The lower or bottom display panel 292 displays thumbnail images or representative names of any files that have been moved into the ShapeShifter software component. Individual content files may be selected from the lower display panel 292 and a full version may be displayed in the center display panel 293. FIG. 3B illustrates the sixth image of a plurality of images being displayed in the bottom display panel 292. The right panel 294 displays information about the selected content file (i.e., file name, file type, file size, category, additional comments, etc.), which may be the file which is currently being displayed in the center panel 293.

The ShapeShifter software component also may incorporate local media files. If files are to be loaded from a specific directory, a change local media import directory button (or drop-down menu) may be selected and the new directory listing may appear in a panel. Under certain operating conditions, the change local media import button is in a lower left panel and the new directory listing appears in the panel. The local content files may be selected and dragged to a lower display panel 291. The local content files are dropped there. The ShapeShifter software component gathers current information about each of the dragged content files (e.g., file name, file size, image attributes, etc.) and transmits this information to the content database. Each of the content files may also be selected, and the right display panel 294 displays information about that content file. All of the information that was available in the file is already loaded into the appropriate fields of the detail panel, which may be on the right hand side of the content management screen. Under certain operating conditions, the information about the content file may be changed. Under certain operating conditions, a unique identification may be placed on the newly added content file to identify it as being utilized in a certain category or associated with a certain event, e.g., such as a December advertising campaign. Under certain operating conditions, content of the content file is displayed in the center panel 293 of the screen so the display of the content can be reviewed to ensure that the information in the detail panel is correctly associated with the content.

The content management module also includes additional functionality for performing actions on the media files. The content management screen includes a plurality of function selection buttons or icons 296. Illustratively, these function selection buttons include edit, cut, paste, print, play media file, delete media file, etc. The content management screen includes functionality for editing selected media files. FIG. 2J illustrates a Edit Media File screen according to an embodiment of the invention. In this screen, the file name, the file size, the file type, the version, and/or comments may be modified. Under certain operating conditions, only the file name and version fields may be allowed to be modified. The content management module 210 also allows a user to delete specific content files. Illustratively, a content file may be selected from the bottom panel and a “delete media” button may be selected to delete the media file from the ShapeShifter software component. The content management module also allows the playing of a media file. Illustratively, the media or content file may be selected and a “play” button may be selected in order to play the contents of the selected media file.

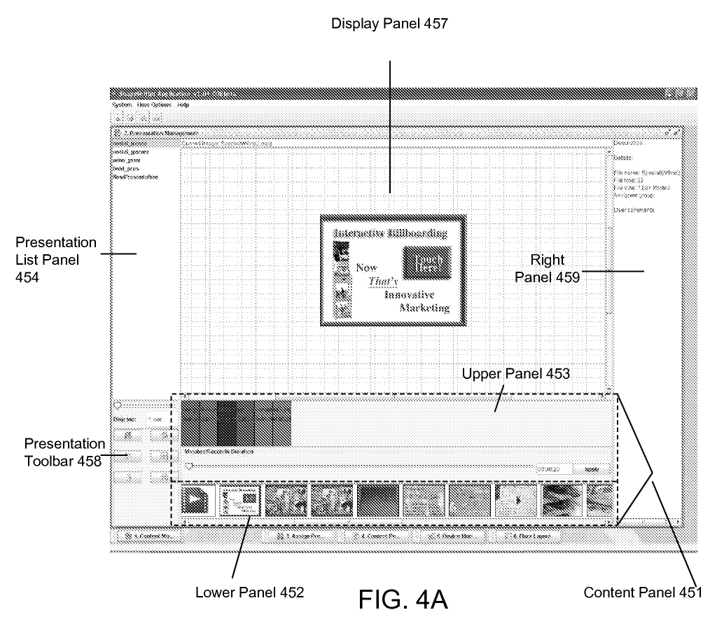

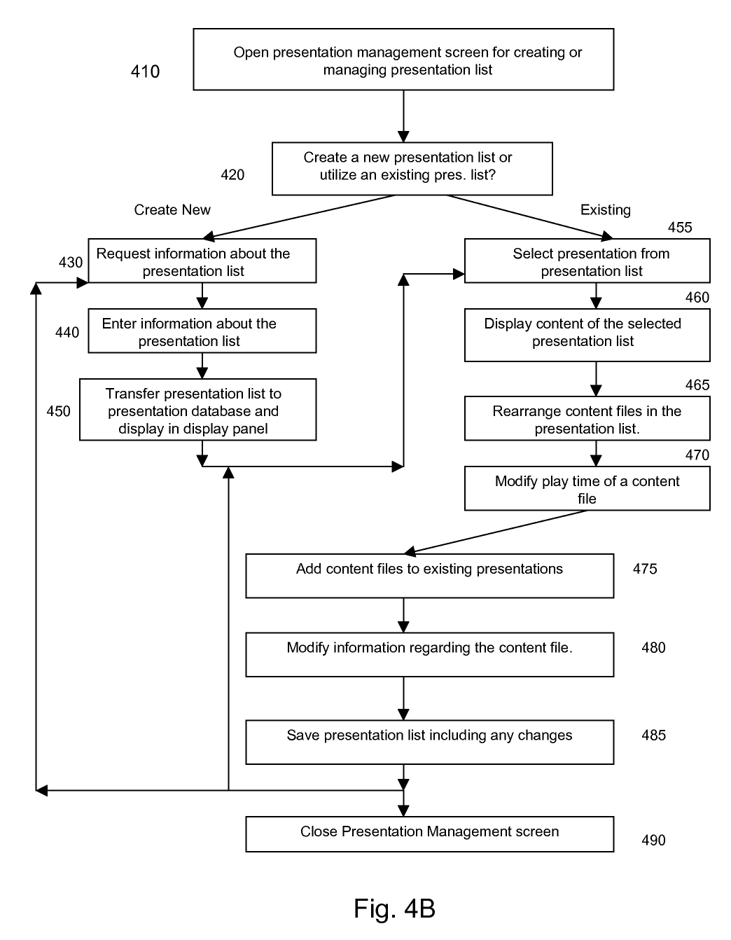

The presentation management module 220 allows the creation of presentations with specific media (or content files), as well as to specify durations of play for each of the content files. The presentation management module 220 also allows the editing, playing, or deletion of presentations. The presentation management module accomplishes the editing functions through drags and drops and mouse click selections on different graphical parts of a content management screen. FIG. 4A illustrates a presentation management screen in the ShapeShifter software component according to the embodiment of the invention. The presentation management screen 400 includes a content panel 451 (including a lower panel 452 and an upper panel 453), a presentation list panel 454, a presentation toolbar 458, and a display panel 457. A presentation may be selected from the presentation list panel, which results in content of the selected presentation being displayed in the content panel 451. A textual and graphical representation of the selected presentation is displayed in the upper panel 452 of the presentation management screen 400. Illustratively, a block (or color bar) may represent each content file in a presentation. FIG. 4A illustrates six such blocks, or presentations. The lower panel 452 displays a number of content files that may be placed in the presentation (which may be alternatively called the presentation container). The upper panel 453 may be arranged in chronological order of play and each content file may be represented by a color bar. The size of the bar may represent the length of play for the content file with respect to the play time of the full presentation. The text of the bar may identify the content file name and the actual duration time for the content file. The upper panel 453 may also include a slider and window timer which identifies the play time of a content file and how much of the content file has been played. In the lower panel 452 and/or the upper panel 453, any of the content files may be selected (e.g., highlighted), and moved to a different location in the presentation (for the upper panel 453) or a different place in the available content list (for the lower panel 452). This may be accomplished via drag and drop movements. The presentation toolbar 458 may also be referred to as the presentation management function selection buttons or icons. Illustratively, with the presentation toolbar 458, an administrator may select to print a media file, print a presentation, delete a media file or presentation, or copy a media file or presentation

The create presentation list and presentation management module 220 allows an individual to create and develop play lists of content files that are to be utilized with display devices in remote or local locations. The presentation management module 220 allows the creation of a new presentation or the utilizing of an existing presentation. FIG. 4B illustrates a flowchart of operation of the presentation management module according to an embodiment of the invention. Initially, the presentation management screen 400 is opened 410. The presentation list panel 454 may list a number of existing presentations. In addition, the presentation management screen 400 may include a toolbar panel 458 (e.g., in the bottom left) which may include a feature for adding a presentation list. Then, it is determined 420 whether a new presentation is to be added or if an existing presentation is to be utilized.

If a presentation list is to be added, a window is opened that requests 430 information about the presentation list that is being created. For example, this information may include presentation name, creator name, description of the presentation list, and usage information. The information regarding the presentation list is entered 440 and then the create presentation list module 230 transfers 450 the newly entered presentation list into the content table 122 and the presentation list table 126. The presentation list panel 454 now displays the created presentation as a new presentation. Under certain operations, the newly entered presentation may be highlighted and be ready to receive content.

After a presentation list is selected 455, e.g., selected and highlighted, content in the presentation list may be displayed 460 in a content panel 451 of the presentation management screen 400. As discussed above, the content panel 451 includes an upper panel 453 that displays contents (i.e., content files) of the selected presentation and the lower content panel 452 that displays additional content that may be added to the selected presentation. In an embodiment of the invention, the presentation management module 220 may gather the available content from the content table 122 and the presentation list table 126.

Under certain operating conditions, the content panel 451 may show a representation of various content files that are in the selected presentation list. Under certain operating conditions, the upper panel 453 of the content panel 451 may be arranged in a chronological order of play and may also be represented by a color bar. The size (or length) of the bars may correspond to or be representative of the length of play for that content file with regard to the entire selected presentation list. For example, a small bar may represent 20% of the full 100% play time. The upper panel 453 of the content panel 451 may include for each bar (and thus content file) text identifying the content name for the bar and also the time that the content file is set to be displayed for.

The presentation management module 220 allows for the rearranging of the various content files. A content file may be rearranged 465 in the list of presentations. Illustratively, the third content file from the left may be moved to the end of the presentation list.

A play time of the content file may be changed or modified 470. Under certain operating conditions, a content file having the play time modified may be selected, e.g., using the left mouse button, and a slider symbol may be displayed at each end of the graphical representation of the content file. Illustratively, the slider symbol is displayed in a bottom section of the upper panel 453 and includes the heading of minutes/seconds duration. The cursor may move the slider symbol and drag the slider symbol in one direction to increase the play time, or in the other direction, to decrease the play time.

New content files may be added 475 to the selected presentation. A content file may be located in the lower panel 452 of the content panel 451 and may be selected. Selection of the content file results in the content file being highlighted. The selected content file may be dragged into the upper panel 453 of the content panel 451 from the lower panel 452. After the new content file has been dragged into the upper panel, the new content file is represented by a color bar. The selected content file may be placed into location within the existing presentation list, e.g., first to play, fifth to play, seventh to play.

If one of the color bars representing the content files are selected in the upper panel, an image or sound of the selected content file is displayed in the display panel 457. Details regarding the selected content file are displayed in the right panel 459. Information regarding the content file may be modified by selecting 480 the right panel 459 of the presentation management screen.

After the information regarding the content file is changed (or not changed), the presentation list may be saved 485. The presentation list may be saved to the presentation list table 126 in the centralized database. Under certain operating conditions, information about the content files in the presentation lists may be saved to the presentation list table. If there are no more presentations to create or presentation lists to modify, the presentation management screen may be closed 490. The closing of the presentation management screen automatically saves the presentation lists (and potentially information about the presentation lists or content files) to the presentation list table 126. An administrator also has an option to synchronize changes in any modified presentation lists (and modified information about the presentation lists) to the impacted devices by selecting a “go” or “synchronize” button or icon. If another presentation needs to be created, the process may return to step 430, i.e., requesting information about the presentation list. If another presentation list is to be modified or rearranged, the process returns to step 455.

The ShapeShifter software component also includes an assign presentation module 230. The assign presentation module 230 associates specific presentations to a particular device. The assign presentation module also shows the timeline of presentations. The assign presentation module 230 also allows moving of contents of a presentation to better match a device's mask. The assign presentation module 230 selects devices individually, or also by groups. Illustratively, one presentation may be assigned to multiple devices.

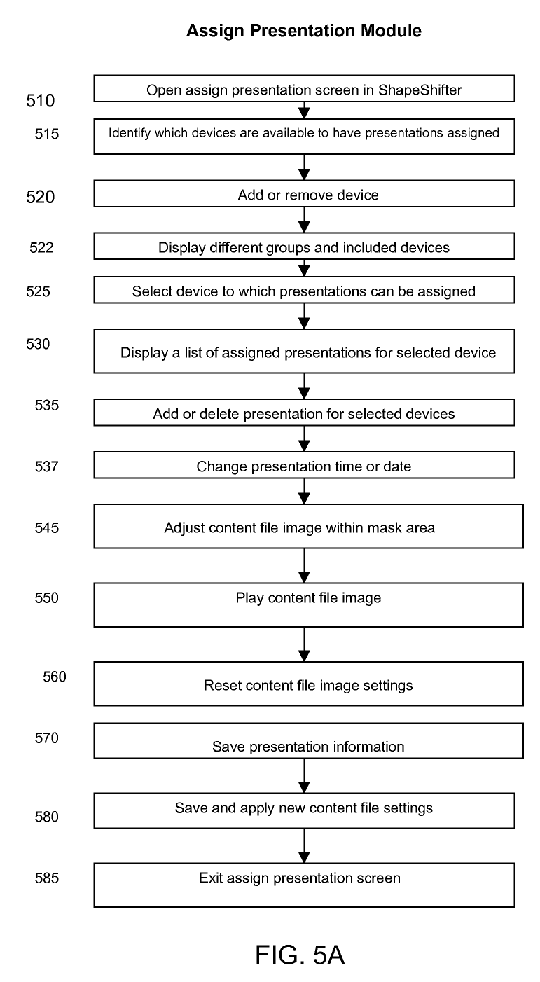

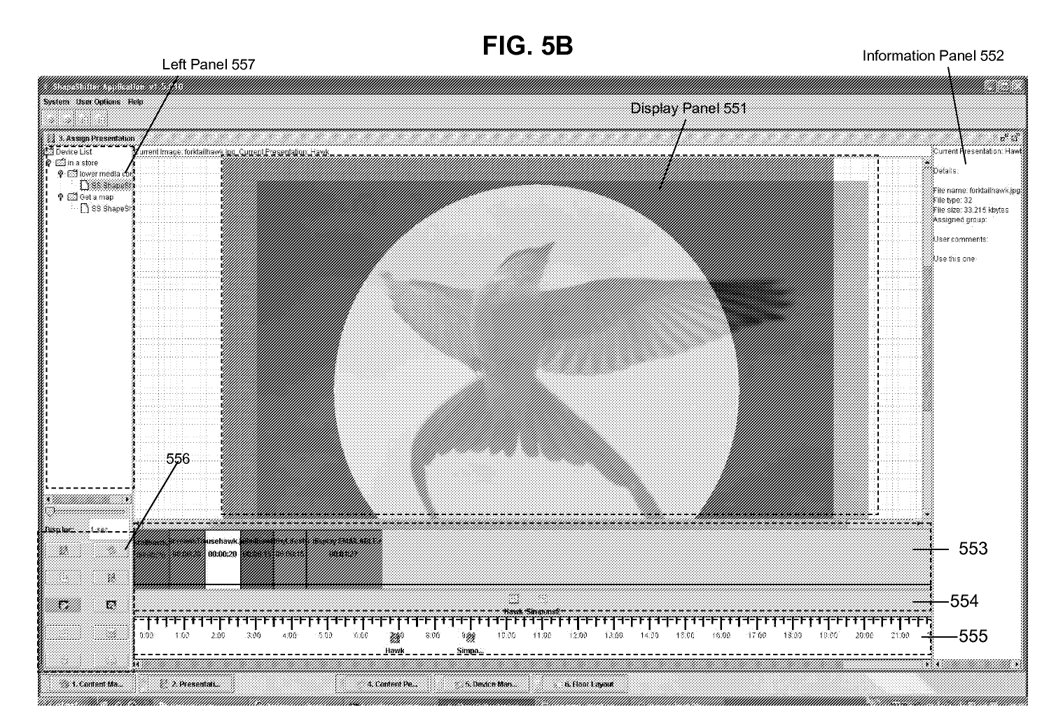

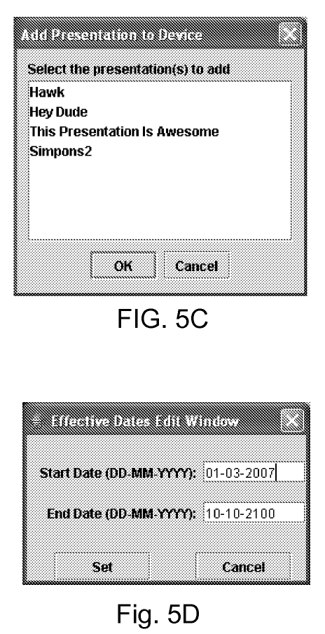

FIG. 5A illustrates a flowchart of the assign presentation module 230 according to an embodiment of the invention. The specific presentation list can be associated with a device or various presentation devices out in remote locations. Once the presentation list is associated with a presentation device, the content files of the presentation list are mapped to the presentation device and also may be sent to the presentation device in preparation for the content files to be displayed. In order to assign presentations to specific presentation devices, an assign presentation screen is opened 510, e.g., via an assign presentation button off of the main menu screen. FIG. 5B illustrates an assign presentation screen according to an embodiment of the invention. The assign presentation screen includes a display panel 551, an information panel 552, a presentation content panel 553, a presentation list panel 554, a presentation list duration panel 555, a function selection panel 556, and a left panel 557. A panel 557 in the assign presentation screen displays 515 available devices to which presentations can be assigned. The panel may be a left panel 557 of the assign presentation screen. The assign presentation module 230 may allow a device to be added or removed 520. The assign presentation screen may include a menu selection or a button for adding or deleting of presentation devices. The button or an icon may be located in the function selection panel 556. If a device is to be deleted, the device is first selected and then the delete device menu item is selected. A delete device button or icon may be located in the function selection panel 556. If the presentation device is to be added, the menu option, an add device button or icon is selected from the function selection panel 556 and an input menu may appear. The assign presentation module also allows a user to view 522 the different groups assigned in the digital marketing system and to identify which devices are assigned to each of the groups. A menu option may be selected to view the different groups and devices assigned to the different groups. The menu option may be selected via a button or icon in the function selection panel 556.

A device may be selected 525 to have presentations assigned to it. The assign presentation module 230 may display 530 a list of associated presentations (or presentation lists) for the selected device in a presentation list panel 554 of the assign presentation screen. The presentation content panel 553 of the assign presentation screen may display the content files of the selected one presentation list.

A presentation may be added or deleted 535 for the selected presentation device. FIG. 5C illustrates an add presentation menu option according to an embodiment of the present invention. The add presentation menu option may be selected via a button or icon in the function selection panel 556 of the assign presentation screen. A number of available presentations are displayed, e.g., ones that have not been associated with the selected device. A user may select one or more of the listed presentations to be added to the selected presentation device. The assign presentation module may also delete presentations for the selected device. A list is displayed for the selected device and one of the presentations is highlighted, and later deleted. The assign presentation module 230 removes the presentation from the selected device, but does not delete the presentation itself from the digital marketing system (e.g., the content table 122 and/or the presentation list table 126).

The assign presentation module 230 allows for the modification 537 of the presentation time or date. The presentation list direction panel 555 of the assign presentation screen also displays a time scale for each of the associated presentations that identifies how long each of the associated presentations play for. Illustratively, if only one presentation is associated with the selected presentation device, then the one presentation continually plays if the selected device is operational and utilizing the Shapeshifter software component. If there are two or more presentations assigned to the selected device, then each can be assigned a starting time to play. As illustrated in FIG. B, a plurality of presentations may be associated with a device and displayed in the presentation list panel 554 of the assign presentation screen. In the presentation list duration panel 555 of the assign presentation screen, the assign presentation module 230 may display a starting time for each of the associated presentations for the presentation device. The starting time of the associated presentations may be modified or changed. Illustratively, the presentation list (e.g., Simpons2 in FIG. 5B can be selected and then moved along the displayed time scale. The presentation list may then be dropped at the time that the associated presentation is to begin to start to play. This results in the presentation having its starting time its starting time modified.

After the start time information is changed, this information may be transmitted to impacted devices by an administrator. The administrator may first save the start time information to the time zone table 123, the device table 124, and the presentation list table 126. The administrator may then synchronize the modified start time information with the impacted devices by selecting a “synchronize” button. The actual content image or the content image display time may not be changed from the assign presentation screen. The assign presentation module also allows for an individual to edit present data, e.g., start and expiry dates for a presentation (presentation list). FIG. 5D illustrates an effective dates edit window screen according to an embodiment of the invention. Start dates and end dates may be entered into the edit window screen. The presentation may start at the specified start date and may cease at the end of the specified end date.

The assign presentation module 230 may also allow for the position of the image within the device mask to be shifted 545 or moved under operating conditions if the auto match mask function is not selected for a selected presentation device. A presentation may be selected or highlighted in the presentation list panel 554 of the assign presentation screen and a content file associated with the selected presentation may be selected from the presentation content panel 553 of the assign presentation screen. After the content file is selected, the content file image is displayed in a display panel 551 of the assign presentation screen and details of the content file are displayed in an information panel 552 of the assign presentation screen. In response to the content file being selected, the assign presentation module may displays the selected content file under a device mask in the display panel 551 of the presentation screen. Illustratively, the assign presentation module displays the selected content file under the device mask in the display panel 551 panel, which is semi-gray wherever the content file image does not show up on the display area of the target device. The content file image shows up clearly on the assign presentation screen in the same fashion as the content file image would show up on the target display.

The assign presentation module 230 also allows the playing 550 of a content file image. The playing of a content file image may be selected via a button or icon in the function selection panel 556 of the assign presentation screen. A presentation is selected in the presentation list panel 554 and a content file is selected in the presentation content panel 553. An individual may then select to play the content file. Illustratively, the play function may be utilized for movie files and the selected files may be played for viewing in the display panel 551 of the assign presentation screen.

The assign presentation media module also allows for resetting 560 of media position in a current mask for a selected media file. In response to the resetting of the media position, the media file's location moves back to a an initial position (e.g., a 0, 0) in the display panel 551.

A device's assigned presentations may be saved 570 in the digital marketing system, e.g., the Epson SmartTouch system. Illustratively, the presentation device's assigned presentations may be saved to the device table 124. In addition, the assigned presentations may be saved in an presentation list to device table 128 in the centralized database. The information may be also saved (in any relevant information was modified) to the presentation list table 126.

Any changes made to presentations may be applied 580 to all of the devices in the digital marketing system that are impacted by the selection of an apply changes menu item. This may also be referred to as a synchronize button or icon. After the presentations have been associated with various devices, the apply changes or synchronize selection may distribute the changes to all devices associated with or impacted by the presentation. Illustratively, this may be accomplished by transmitting the changes to the impacted devices in the digital marketing system.

After one of the presentations devices has had presentations assigned to it (i.e., presentation lists associated with it), an additional presentation device may be selected and the process returns to step 525 of FIG. 5. After all of the changes have been made and the presentations has been associated with the devices, the assign presentation screen may be closed 590. The closing of the assign presentation screen may automatically apply changes in the presentation lists, the associations, or the devices to the presentation list table 126, the device table 124, and/or the presentation list to device table 128.

The Shapeshifter software may include a content personalization module 240. The personalized content module 240 may allow an authorized individual to add personalized content to existing advertising content. Illustratively, the content personalization module may allow the user to edit and position temporary text information on a particular device. Specific text information can be input and the content personalization module 240 may specify how the information is to be displayed and where the information is to be displayed on the screen. The content personalization module 240 may allow the selection of multiple devices in order to display the same information across many information.

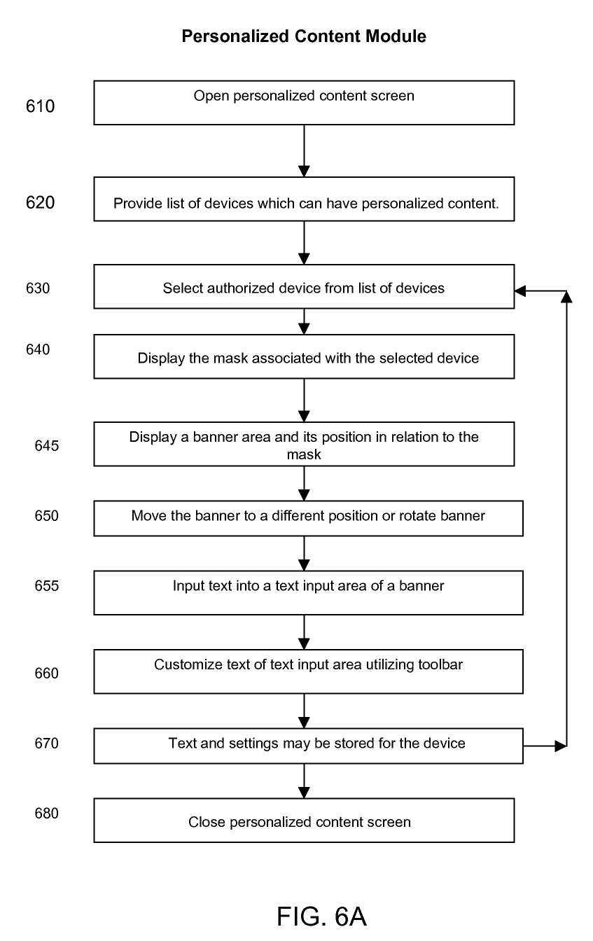

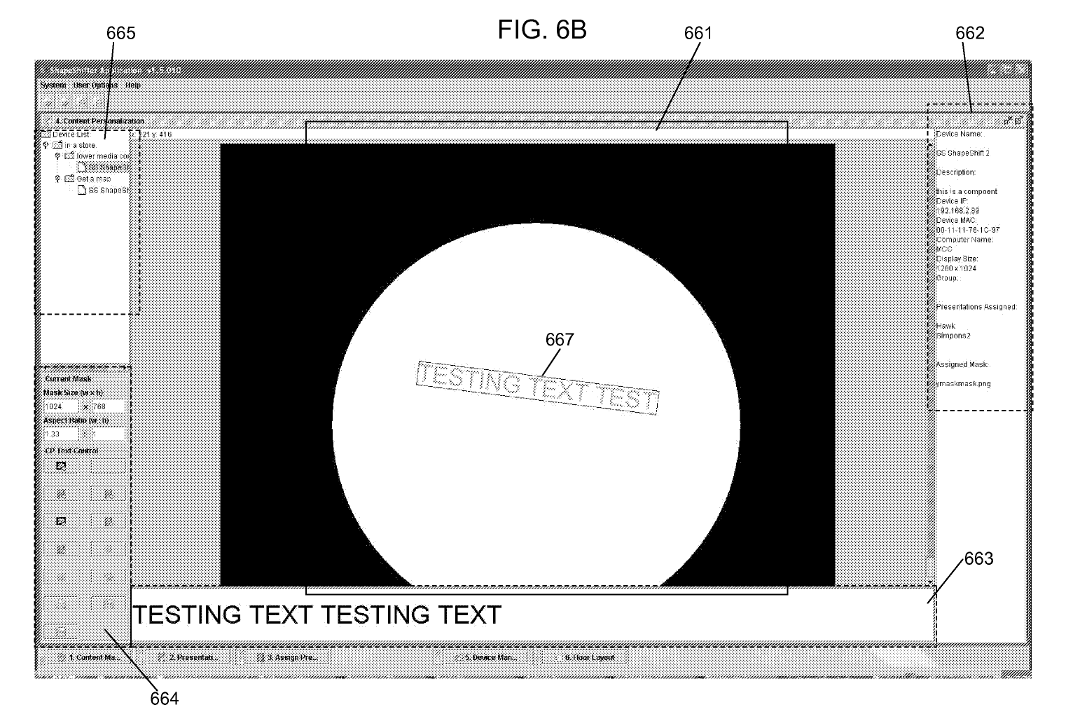

FIG. 6A illustrates a flowchart of operation of the content personalization module according to an embodiment of the invention. Under certain operating conditions, the content personalization module may operate by opening 610 a content personalization screen. FIG. 6B illustrates a content personalization screen according to an embodiment of the invention. Under certain operating conditions, the content personalization screen may provide 620 a list of authorized presentation devices to which personalized content may be added. Under certain operating conditions, the list of authorized devices may be in a left panel 665 of the content personalization screen. A device may be selected 630 from the list of authorized devices. After the presentation device is selected, the content personalization screen may display 640 a mask associated with the selected presentation device. Under certain operating conditions, the mask may be displayed in a display panel 662 of the content personalization screen. Information about the device, the presentations assigned, and the mask assigned may be displayed on the information panel 662 of the content personalization screen. In an embodiment of the invention, the content personalization screen may display 645 a banner area and its position in relation to the displayed mask. Text in the banner area may scroll across the masked area. In FIG. 6B, the banner area is illustrated by reference number 667. Under certain operating conditions, the banner may be moved 650 to a different position in relation to the mask. Alternatively, the banner area 667 may be rotated to different areas around the mask. The personalized content module 240 may include a text input panel 663, as illustrated in FIG. 6B. The entry 655 of text into the text input panel 663 results in the text being scrolled in the banner area while the presentation is being displayed. Illustratively, the scrolling text panel at the bottom of the content personalization screen is an area where an individual can enter in the text that is to be scrolled while the presentation is being displayed. Under certain operating conditions, a function selection button or icon in a function selection panel 664 may be selected 660 to allow the user to customize the text, (e.g., modify font, size, color, etc., of the text). Under certain operating conditions, as the text is entered, the text is placed in the banner area 667 which is displayed above the text. After selection and authorization of the text, the text (and/or settings) can be saved 670 and stored. For example, the text may be saved in the content personalization table 127 An administrator also has an option of sending the modified or added text to the impacted devices by initiating a synchronizing command. After the text has been saved and stored, a new device may be selected from the list of authorized devices and the process may move back to step 630. If all personalized content has been entered for each of the selected presentation devices, the content personalization screen may be closed 680. Closing of the content personalization screen also stores any changes made during the session to the impacted tables, and specifically, the content personalization database.

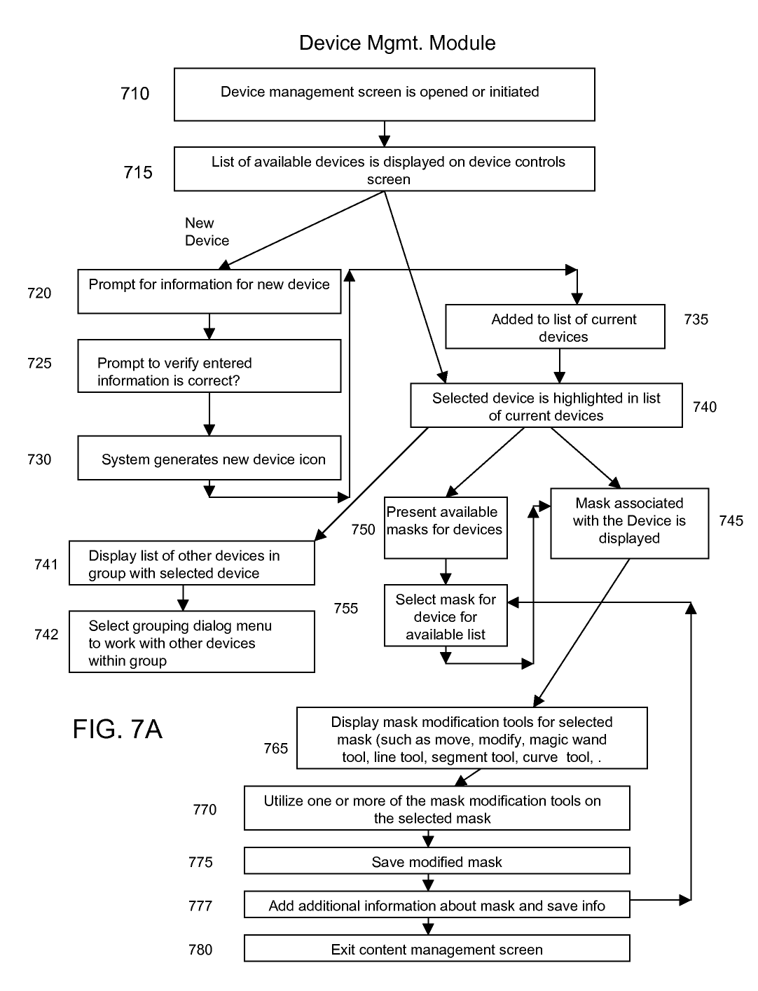

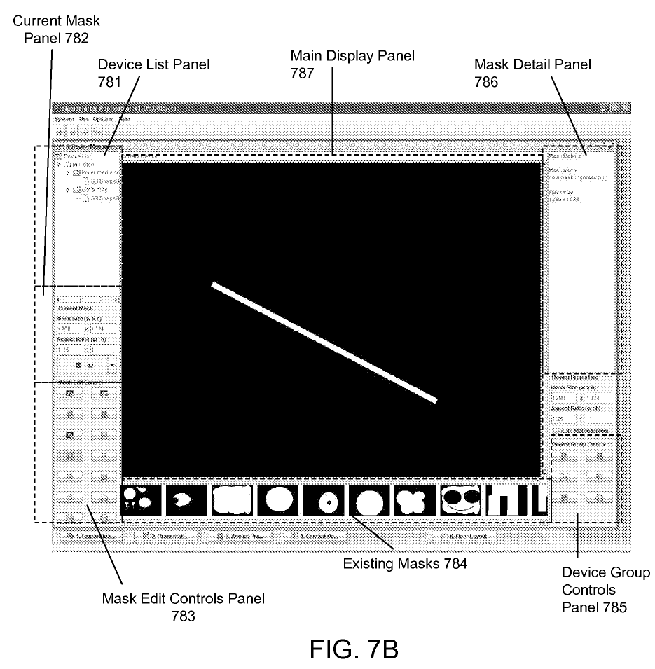

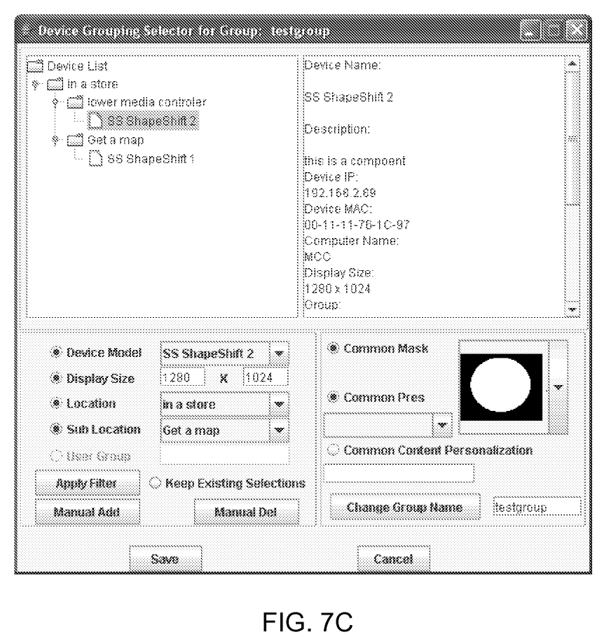

The ShapeShifter software component includes a setup and mask module, which also may be referred to as the device management module 250. The setup and mask module or device management module 250 allows a device to be established or deleted. The setup and mask module or device management module also allows for target area maps to be associated with created devices. The device management module 250 also allows for the assigning and modifying of device masks. Under certain operating conditions, a device may have already been physically set up and attached to the ShapeShifter system. The device management screen of the device management module 250 includes a device group controls section and a mask edit controls section. A mask edit control section of the device management screen provides a plurality of mask modification tools that may be selected to modify the selected or associated mask. FIG. 7A illustrates a flowchart of operation of the device management module according to an embodiment of the invention. FIG. 7B illustrates a device management screen according to an embodiment of the invention. The device management screen includes a device list panel 781, a current mask panel 782, a mask edit controls panel 783, an existing masks panel 784, a device group controls panel 785, a mask detail panel 786, and a main display panel 787.

Initially, a device management module opens or initiates 710 the device management screen. After the device management screen is initiated, the device management module generates 715 a list of current devices along a panel of the device group controls screen. This may be the device list panel 781. New devices may be added to the system using a device group controls subscreen 785. If a new device is added, the device group control 785 prompts 720 for information regarding the presentation device to be created (e.g., device name, device type, location, hours of operation, etc.). After the information has been entered, the device group control subscreen prompts 725 for verification that the entered information is correct. If verification is received, a new device icon is created 730 on the device group controls subscreen and also appears in the device list panel 781. Under certain operating conditions, the list of updated available devices is displayed in a device list panel 781 of the device management screen. Under certain operating conditions, the added device may be highlighted and also may be ready for associating a mask with the added presentation device. The device may also be added to the device table 124.

In an embodiment of the invention, the Shapeshifter software component may automatically identify that a new device has been connected to the Epson digital marketing system. In other words, the device management module may identify that a new projector, kiosk, computer display, etc., have been connected to a store which has a communication network connection to the Epson digital marketing system. The device management module may transmit a query to the newly added presentation device requesting information from the presentation device. The presentation device responds to the query by transmitting specific device information. For example, the device information may include projector model, projector manufacturer, hours projector been on, aspect ratio, whether the projection device has either a DVI input or VGA input, display characteristics of projection device, projection device polling method or timeframe, expanded display characteristics, communication characteristics, protocols supported, file types able to be displayed, and/or whether or not camera input may be received directly. This feature decreases the amount of manual input needed to complete the entering of information on the device group control subscreen. If this feature is invoked, (which may be called the intelligent characteristic querying, the device management module may automatically create a new device icon after the projection device provides the device information.

A presentation device may be selected 740 on the device management screen. After the device is selected, the device management screen may display 745 a current mask associated with the selected device, if a mask has been established for the selected device. The mask may be displayed on the main display panel 787. Information regarding the mask may be displayed in the current mask panel 782. Under certain operating conditions, the device group control screen, if there is no mask that has been established for the selected presentation device, may display 750 a number of existing masks that can be associated with the selected device. The number of existing masks may be displayed in the existing mask panel 784. If there was no mask associated with the device, one of the existing masks may be associated 755 with the selected presentation device. The device management screen may display 745 the mask associated with the selected device in the main display panel 787. The device management screen also allows the disassociation of a mask with a selected device by the selection of a menu option.

A group controls subscreen may also display 741 other devices within the same group as the selected device. A menu item may be selected to display the other devices within the same group. The group control screen also includes a device grouping selector subscreen which receives displays the devices within the same group, displays information about the devices, and provides 742 for the selection of a common mask, a common presentation list, common customization, etc. for devices within the same group. FIG. 7C illustrates the device grouping selector subscreen according to an embodiment of the invention. The mask edit controls panel 783 includes a number of tools that can be utilized to modify a selected mask. The mask edit controls panel displays 765 the tools that can be utilized to modify the selected mask. One or more of the mask edit controls may be utilized 770 on the selected mask. After the one or more mask edit controls have been utilized on the selected mask, the modified mask may be saved 775. In addition, the ShapeShifter software component may request 777 additional information for the mask associated with the device. This information may include a distance of the display area from the display device, physical size of the display area, etc. This additional information may be saved 777 for the mask. Illustratively, the information regarding the mask may be saved in the mask database 121 and/or the content database 122. An additional mask may be modified or the device management screen may be exited 780.

One of the mask edit tools is the area image tool. If the area image tool is selected, a display area shape is selected and an image of the display area is shown in the main display panel 787. A magic wand tool may also be selected and a cursor may be placed over the image of the displayed area. In response to an user input, such as a left mouse button, the magic wand tool attempts to trace the image of the display area to create an outline of the mask. A segment tool may be selected. The segment tool allows the selecting of a segment of the mask. After selecting a segment of the mask, the segment may be moved or stretched more closely fit the image of the display area or the image that is desired.

Alternatively, if there is no image to trace, a line tool may be selected. The mask may be created by moving the cursor to certain points and creating lines between the selected points. The mask may be created when the first point created is connected to the outline of the additional points. A mask may be further modified by selecting a specialize tool. Within the specialize tool, a curve may be selected and a segment can be selected to which the curve is to be applied. The device management module may provide guides for the specialized tool (via on-screen help) to identify how much the segment may be manipulated, e.g., what types of curves are available, how many degrees of curve that may be utilized, etc.

The presentation management module also includes a create new mask option, which allows the user to create a new mask and select an appropriate target resolution size. The device management module also includes a create mask from a loaded file option. A file is selected and loaded and a mask is created from the loaded file.

A mask may be deleted by selecting one of the masks from the existing masks panel 784. After the mask is selected, a delete option may be selected to remove the mask from the backend system. The device management module 250 includes a line-draw mode to draw lines on a mask being created or modified. The device management module 250 includes a rectangle draw mode to draw rectangles on the mask that is being created. The device management module 250 includes a undo last drawing action to undo the last shape that was created. The device management module 250 includes a set all areas option to change all areas that are non-white to black (or vice versa). The set all areas option also allows the establishing of a color. The device management module 250 includes a select erase mode option to draw over and fill in any shapes that should not remain on the selected mask.

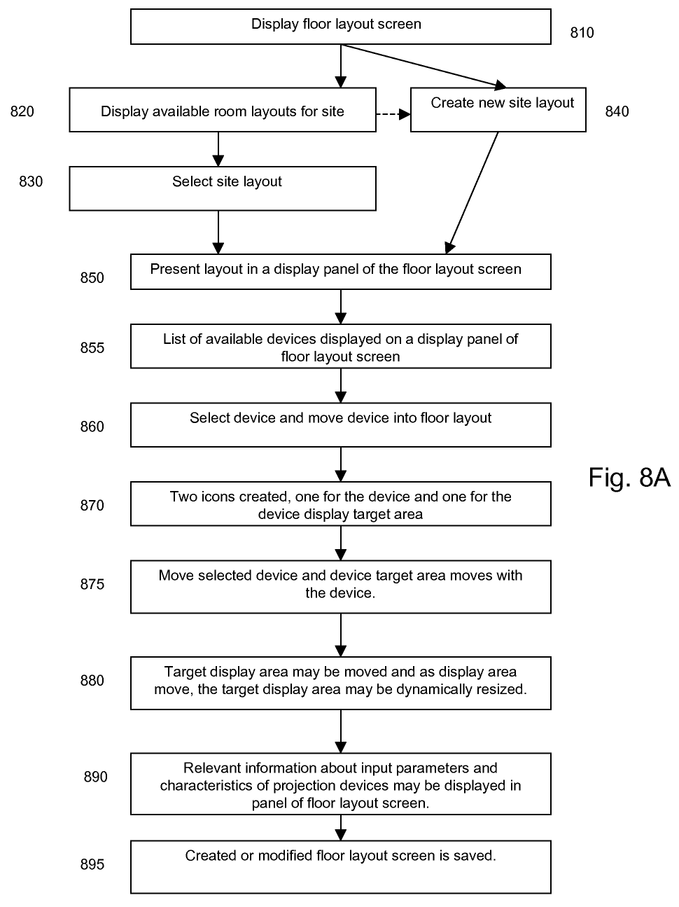

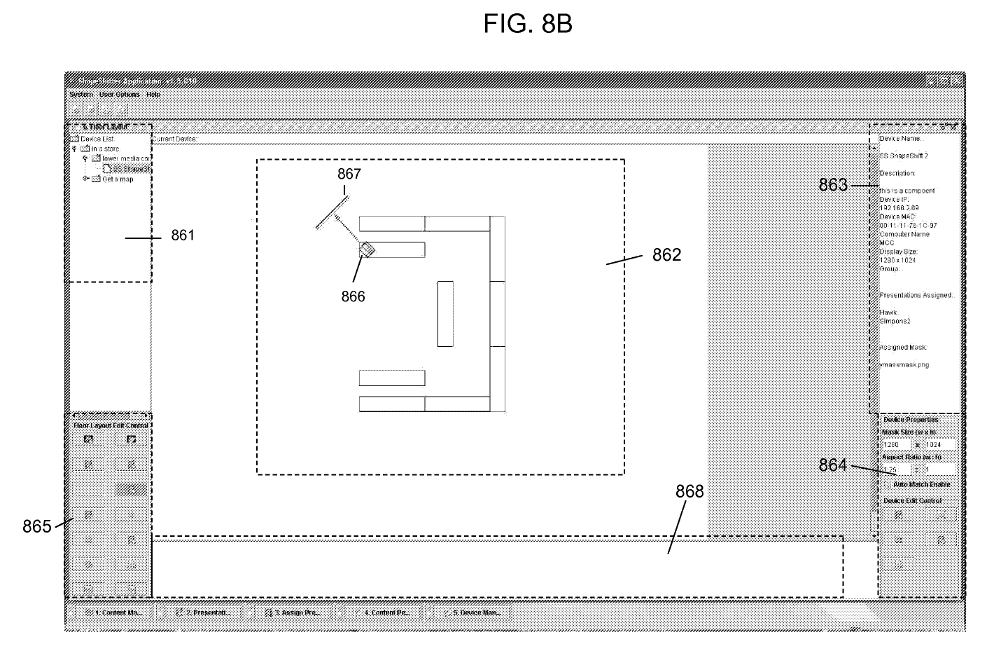

The Epson Shape Shifter software includes a floor setup or layout module. FIG. 8A illustrates a flowchart for operation of the floor setup module according to an embodiment of the invention. The floor setup module allows a design of a physical display layout using a plurality of devices. In order to be able to operate the floor setup module, a number of devices have to be activated or associated within the system.

After the floor setup module is initiated, a floor layout screen is displayed 810. FIG. 8B illustrates a floor layout screen according to an embodiment of the invention. Under certain operating conditions, the floor setup module presents 820 a list of existing layouts. Although available floor layouts are not displayed in the embodiment of the invention illustrated in FIG. 8B, the floor layout panel 868 may display a number of potential floor layouts. One of the existing layouts may be selected 830. If there are no acceptable layouts appropriate for a space or if a new layout is required, a create layout icon may be selected. The floor setup module may create 840 a new layout based on the user instructions.

A floor layout may be selected and the layout may be presented 850 in a display panel 862 of the floor layout screen. Under these operating conditions, the list of available devices may be displayed 855 in the device panel 861 of the floor layout screen. A device may be selected 860 and may be moved into the selected floor layout (e.g., the display panel 862). This may be accomplished via dragging and dropping the device. After the device is selected and moved, the floor layout module creates 870 two icons, one representing the device selected (illustrated by reference number 866 in FIG. 8B) and one representing the display target area (illustrated by reference number 867 in FIG. 8B) for that device. Under certain operating conditions, the selected device 866 may be moved 875 around the floor layout. In response to the movement of the device, the display target area 867 may be moved. Under certain operating conditions, the target display area 867 may be moved 880. The device 866 does not move with the target display area 862. When the target display area 867 is moved, the display panel in the floor layout module shows the distance from the device 866 and the target display area 867 as the target display is being moved. The floor layout module dynamically resizes the display target area 867 relative to the selected device 866 as the target area 867 is being moved. The floor layout module is able to perform the dynamic resizing of the display target area due to the input parameters of the device and the mask associated with the device. In an embodiment of the invention, the relevant information about the input parameters of the device may be displayed 890 on an information panel 863 of the floor layout screen. Device properties may be displayed in the device properties panel 864 and information regarding devices may be edited in the device properties panel.

Under certain operating conditions, floor layout icons may be dropped on the floor to help orient the layout. Illustratively, these icons may be found in a floor layout edit control panel 865 at the lower left of the screen. The floor layout edit control panel may allow the selection of a type of device, the removal of a device, a drawing button or icon for establishing the room layout, a printing button or icon, a copy button or icon, and a paste button or icon. After the manipulation of the floor layouts, the floor layout module saves the changes of the floor layouts 895 in Epson Shapeshifter software component. Illustratively, the floor layouts may be saved in the floor layout table 125. The floor layout screen may also be closed or exited.

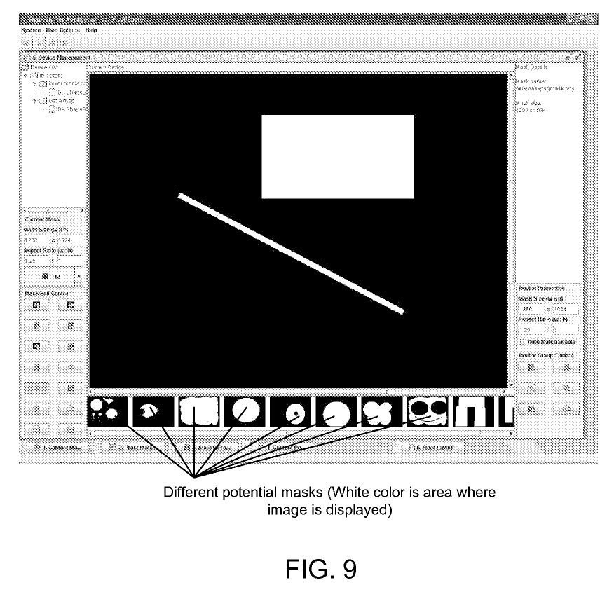

Utilizing the Epson ShapeShifter software component, an administrator may also view how a presentation is to be displayed on the presentation device at the remote location. In other words, the Epson Shapeshifter software component displays the presentation in view of the associated mask. When a mask has been created and associated with a presentation device, for example, the shape of the mask may obscure some of the content image. Outside of the mask may be, for example, a shaded or gray color, and inside of the mask area, images of the content files may be displayed. An administrator may view how content images are displayed in view of masks by selecting any one of the device management screen and the assign presentation screen. The device management screen allows a content file image of a presentation to be displayed in view of its associated mask. The mask may also be modified (e.g., shaped differently) using the device management screen. The assign presentation screen allows for a content file image to be played with the mask associated with the device also being displayed. FIG. 9 illustrates a number of mask that obscuring part of a content file image according to an embodiment of the present invention. These may be displayed in a panel in a lower section of the device management screen.

The invention may be implemented in hardware or software, or a combination of both (e.g., programmable logic arrays). Unless otherwise specified, the algorithms included as part of the invention are not inherently related to any particular computer or other apparatus. In particular, various general purpose machines may be used with programs written in accordance with the teachings herein, or it may be more convenient to construct more specialized apparatus (e.g., integrated circuits) to perform particular functions. Thus, the invention may be implemented in one or more computer programs executing on one or more programmable computer systems each comprising at least one processor, at least one data storage system (which may include volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

A number of embodiments of the invention have been described. Nevertheless, it will be understood that various modifications may be made without departing from the spirit and scope of the invention. For example, some of the steps described above may be order independent, and thus can be performed in an order different from that described. Accordingly, other embodiments are within the scope of the following claims.

1. A method of selecting and modifying a mask associated with a presentation device, comprising:
receiving input to select the presentation device from a plurality of presentation devices;
displaying a mask associated with the selected presentation device;
displaying mask modification tools for associated mask; and
utilizing one or more of the mask modification tools on the selected mask to create a modified mask.

2. The method of claim 1, further including receiving additional information about the selected mask and saving the addition information and saving the additional information in the mask database.

3. The method of claim 1, further including saving the modified mask in a mask table.

4. The method of claim 1, wherein an area image tool is the utilized mask modification tool and the area image tool shows an image of the presentation device display area.

5. The method of claim 4, further including utilizing a magic wand tool, the utilized magic wand tool traceing an outline of the mask based on the image of the presentation device display area.

6. The method of claim 5, further including selecting a segment tool, selecting a at least one segment of the mask outline, and moving the selected at least one segment to modify a shape of the mask outline.

7. The method of claim 5, further including selecting a segment tool, selecting a at least one segment of the mask outline, and stretching the selected at least one segment to modify a shape of the mask outline.

8. A method of selecting and modifying a mask associated with a presentation device, comprising:
receiving a selection of the presentation device from a plurality of presentation devices;
displaying mask creation tools that are utilized to create a mask for the presentation device; and
receiving a selection of a mask creation tool to create the mask for the presentation device;

9. The method of claim 8, wherein the mask creation tool is a line tool and the mask is created by moving a cursor to a plurality of points and creating lines between the plurality of points.

10. The method of claim 9, further including utilizing a specialize mask modification tool to select a curve and a segment to which the curve is to be applied.

11. A method of operating banner associated with a device, comprising:
receiving a selection of a projection device of a plurality of projection devices;
displaying a mask associated with the selected device;
displaying a banner area and a position of the banner area in relation to the associated mask; and
receiving input regarding moving the position of the banner to a different position in relation to the associated mask.

12. The method of claim 11, further including rotating an orientation of the banner in relation to the associated mask.

13. The method of claim 11, further including receiving input text into a text input area of a banner and customizing one of a group of a font, a size, a color and a spacing of the input text.

14. The method of claim 13, further including saving the text and the position of the banner into a mask database.

15. A method of creating a presentation device floor layout, comprising:
presenting a room design layout in a display panel of the floor layout screen;
displaying a list of available presentation devices on a panel of the floor layout screen;
receiving a selection of a presentation device from the list of available presentation devices; and
moving the selected presentation device into the room design layout in the display panel.

16. The method of claim 15, further including creating two icons, a first icon being a device icon and a second icon being a presentation device display target area.

17. The method of claim 16, further including moving the selected presentation device in the room design layout, wherein the presentation device display target area automatically moves in the room design layout in conjunction with the movement of the selected presentation device.

18. The method of claim 17, further including moving the presentation device display target area, wherein the selected presentation device does not move.

19. The method of claim 18, wherein when the presentation device display target area moves the display target area is dynamically resized due to parameters and characteristics of the projection device.

20. The method of claim 19, further including saving changes in locations of the presentation devices to a room layout database.

21. A content presentation system, comprising:
a computing device including software to modify mask information to create modified mask information; to modify presentation list information to create modified device information; and to modify content information to create modified content information;
a mask table for storing the mask information;
a device table for storing the device information; and
a presentation list table for storing the presentation list information.

22. The content presentation system of claim 21, where the computing device further includes software to modify floor layout information to create modified floor layout information and further including a floor layout database to store the modified floor layout information.
